(19) United States
(12) Patent Application Publication
(10) Pub. No.: US 2003/0016280 A1
(43) Pub. Date: Jan. 23, 2003

(54) Ink-receptive composition

(76) Inventors: Xing-Ya Li, San Gabriel, CA (US); Kenneth Lin, San Marino, CA (US); Zhisong Huang, Arcadia, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/881,459

(22) Filed: Jun. 14, 2001

(51) Int. Cl. B41J 3/407; B32B 3/00

(52) U.S. Cl. 347/106; 428/195

(57) ABSTRACT

A composition for making glossy, ink-receptive coatings for recording media contains a water soluble, nonionic polymer, a water soluble, amphoteric copolymer, and a polyalkylene glycol or silicone surfactant. Ink-receptive constructions made with the composition also are provided.

### FIELD OF THE INVENTION

The present invention relates to compositions for enhancing the quality of imprintable substrates, in particular ink jet-printed sheets, labels, transparencies, and other constructions.

### BACKGROUND OF THE INVENTION

Ink receptive sheets, papers, labels, transparencies, and other products are widely used in the office and home, as well as in commercial print settings. Ink jet printers, which form an image by ejecting discrete drops of ink from one or more nozzles onto a recording sheet, have surged in popularity and, in conjunction with new software, enable a tremendous variety of fonts, designs, and even photographs to be printed. At the same time, digital cameras have made it possible for consumers to store a photographic image in computer memory and, when desired, print out a photograph with nearly the same ease as black and white text.

Although efforts have been made to produce high quality ink-receptive sheets and other constructions, a continuing need exists for high quality, ink-receptive media characterized by high resolution, high color density, good color gradation, and other print qualities. There also exists a need for ink-receptive materials that facilitate fast drying of water-based inks, smudge-proofness, water-fastness, and compatibility with both pigment-based and dye-based inks. The need for high quality photorealistic paper is particularly acute. One property demanded of photorealistic paper and similar recording media is high gloss, mimicking that of a conventional photograph.

### SUMMARY OF THE INVENTION

The present invention provides glossy topcoats and coatable compositions for ink-receptive media; labels, sheets, and other constructions made with the glossy topcoat; and new amphoteric copolymers which, when formulated with other components, can be used to prepare an ink-receptive composition.

According to a first aspect of the invention, a composition for making a glossy topcoat for ink-receptive media comprises a mixture of at least three components: (i) a water soluble, nonionic polymer, such as polyvinyl alcohol, water soluble cellulose derivatives, gelatin, etc.; (ii) a surfactant, preferably a water soluble polyalkylene glycol or silicone surfactant.

The amphoteric copolymer constitutes a second aspect of the invention, and is formed of a plurality of monomers, including about 50 to 90% by weight cationic monomers, about 10 to 30% by weight anionic monomers, and 0 to about 30% by weight neutral monomers.

In a third aspect of the invention, an ink-receptive construction includes a substrate of paper, film, or other base material, and an ink-receptive topcoat as described herein. In an alternate embodiment, the ink-receptive construction contains multiple layers, including a substrate, one or more intermediate layers, and a glossy topcoat as provided herein. Nonlimiting examples of ink-receptive constructions include papers, films, labels, (including clear inkjet labels) sheet protectors, transparencies used with overhead projectors, photo sheets, and photo album sleeves

### BRIEF DESCRIPTION OF THE DRAWINGS

FIG. 1 is a schematic view of one embodiment of an ink-receptive construction according to the present invention.

FIG. 2 is a schematic illustration of a second embodiment of an ink-receptive construction according to the present invention.

FIG. 3 is a schematic illustration of an alternate embodiment of an ink-receiving and fixing layer of an ink-receptive construction shown in FIG. 2.

### DETAILED DESCRIPTION OF THE INVENTION

According to a first aspect of the invention, a composition useful for preparing ink-receptive media—in particular, ink-receptive topcoats for ink-jet printers, sheet protectors, transparencies, and other products—comprises a mixture of at least three components: a nonionic, water soluble polymer, preferably selected from the group consisting of polyvinyl alcohol, water soluble cellulose derivatives, gelatin, and chitosan; a second polymer, which is a water soluble amphoteric copolymer; and a surfactant, preferably a water soluble polyalkylene glycol or silicone surfactant. Preferably, the composition also includes a crosslinker and, in some embodiments, a pigment.

Although actual proportions of the composition can vary depending upon the intended application, in general, ink-receptive compositions according to this first aspect of the invention are prepared by mixing the three components at a relative weight ratio of about 50-90% first polymer (nonionic), about 10-50% second polymer (amphoteric), and about 1-5% polyalkylene glycol or silicone surfactant. If too much glycol or surfactant is present, the composition, when coated and dried on a substrate, may exhibit reduced water reistance.

The first polymer is water soluble, or at least hydrophilic, and substantially nonionic. One example is polyvinyl alcohol (PVOH), which comes in a variety of grades and saponification levels (mole percent hydrolysis of polyvinyl acetate). Highly saponified PVOH is preferred, as it is more soluble in water. A preferred PVOH has a saponification level of about 85 to 95%, more preferably about 87 to 89%.

Other examples of water souble, nonionic polymers include water soluble cellulose derivatives, gelatin, and chitosan. Nonlimiting examples of water soluble cellulose derivatives include hydroxyethylcellulose, hydroxypropylcellulose, carboxy-methylcellulose, methylhydroxycellulose, and methylhydroxypropyl cellulose. It will be apparent to persons skilled in the art that, although the aforementioned polymers contain hydroxyl groups (and, therefore, exhibit a small pKₐ), they are nonetheless considered to be nonionic polymers.

The second component of the composition is a water soluble, amphoteric copolymer. As used herein, the term “amphoteric” refers to a substance having both cationic and anionic groups within the same molecule. This definition includes molecules that become zwitterionic by adjusting the ambient pH. According to one embodiment of the invention, an amphoteric copolymer is prepared by copolymerizing a mixture of cationic and anionic monomers and, optionally, one or more neutral monomers. The neutral monomers are selected to improve polymer strength or other properties. Preferred monomer weight percentages are as follows: cationic monomers: about 50 to 90% (more preferably about 60 to 80%); anionic monomers: about 10 to 30% more preferably about 10 to 20%); neutral monomers: 0 to about 30% (more preferably about 10 to 20%) based on the weight of all monomers.

Preferred cationic monomers include trialkylammoniumalkyl (meth)acrylates, e.g., dimethylaminioethylmethacrylate methyl chloride quaternary salt (a trimethylammonium chloride available from Ciba Speciality Chemicals, Tarrytown, N.Y., under the trademark “AgeflexFM1Q75MC”); allylalkyl ammonium salts; and vinylbenzylammonium salts. Preferred anionic monomers include (meth)acrylic acid, and acrylamido-2-methylpropane sulfonic acid (“AMPS®”). Beta-carboxyethylacrylate (beta-CEA) and itaconic acid are two other examples of anionic monomers. Preferred neutral monomers include acrylamide, dialkylaminoalkyl (meth)acrylates, hydroxyalkyl (meth)acrylates (e.g., hydroxymethyl acrylate, hydroxymethyl methacrylate, hydroxyethyl acrylate, hydroxyethyl methacrylate, hydroxypropyl acrylate, and hydroxypropyl methacrylate), and N-vinyloxazolidone.

A particularly preferred amphoteric copolymer is formed from a plurality of monomers comprising, on a percent by weight basis, about 60 to 80% dimethylaminioethylmethacrylate methyl chloride quaternary salt (e.g., AgeflexFM1Q75MC), about 10 to 20% (combined) acrylamido-2-methylpropane sulfonic acid and acrylic acid, and about 10 to 20% hydroxymethyl acrylate. AMPS® is the preferred anionic monomer, but including a small amount of acrylic acid facilitates copolymer crosslinking.

The amphoteric copolymer is prepared using conventional polymerization techniques known to those skilled in the art. Solution polymerization in water is preferred. In general, a plurality of monomers is heated in the presence of a free radical polymerization initiator, optionally by varying the rate of addition of monomers and/or initiator to the reaction mixture. For example, in one embodiment, a reactor is purged with nitrogen, charged with a mixture of monomers and deionized water, and heated to about 45° C. An aqueous solution of one or more initiators is added, with stirring, and polmerization proceeds until complete. Additional initiator can be added to cook-off any residual monomers. If desired, a base is added to adjust the pH of the resulting polymeric composition.

The third component of the composition is, preferably, a water soluble polyalkylene glycol. Nonlimiting examples include polyethylene glycol (PEG) and polypropylene glycol (PPG). Also included are block copolymers of ethylene oxide and propylene oxide, such as the Pluronic® and Tetronic® surfactants manufactured by BASF. Polyethylene glycols are substantially water-soluble at all molecular weights. Polypropylene glycols, however, become increasingly less water-soluble at molecular weights above 425. Polyethylene glycols are particularly compatible with ink jet printer inks formulated with ethylene glycol. Polyethylene glycols with weight-average molecular weights (M_{w}) of 600 or higher, more preferably 1000 or higher, are preferred.

In some embodiments, the third component of the composition is a silicone surfactant. A nonlimiting example is Silwet 77, from C K Witco Corporation's Organosilicones Group (Greenwich, Conn.).

In most embodiments, it is preferred to include a crosslinker in the composition, to improve ink-receptivity and waterfastness of the composition and coated constructions prepared therewith. Nonlimiting examples of crosslinkers include dialdehydes, such as glyoxal (O═CHCH═O) and Sequarez 755 (a polyethoxylated dialdehyde from GenCorp (Fairlawn, Ohio)). Preferred crosslinker concentrations are about 0.5 to 3% by weight of the composition.

In some embodiments, a pigment is included in the formulation. Ink-receptive topcoats with high pigment loadings have substantial microporosity, which results in improved water resistance and faster ink drying times. The tradeoff is a loss of clarity; highly pigmented topcoats (containing, e.g., as much as 60 to 80% by weight pigment) tend to be translucent, or even opaque. If an optically clear topcoat is desired, low pigment concentrations (0 to about 20%) are preferred. In many applications, however, optical clarity is not required. For example, so-called “contact clear” labels are translucent until applied to an envelope or other surface, at which point they look transparent, resulting in a “label-free” appearance.

A nonlimiting example of a highly pigmented ink-receptive composition according to the invention contains, e.g., 75% pigment, 20% polyvinyl alcohol, 1 to 2% amphoteric copolymer, and 3 to 4% polyethylene glycol, with a small amount (0.5 to 3%) crosslinker. Very small particle size pigments like collodial silica and collodial alumina hydrate are preferred. At such a high pigment loading, little amphoteric copolymer is required. A less pigmented formulation, however, will generally contain substantially more amphoteric copolymer, in order to achieve the desired ink-receptivity.

Ink-receptive compositions are readily prepared by mixing the components using standard blending techniques known to those skilled in the art. In embodiments containing a pigment, it is preferred to add the amphoteric copolymer last, to avoid precipitation.

The composition can be applied to a substrate to prepare an ink-receptive construction according to a second aspect of the invention. In a preferred embodiment, the composition is applied to a substrate using standard coating techniques. Nonlimiting examples include slot-die, air knife, brush, curtain, extrusion, blade, floating knife, gravure, kiss roll, knife-over-blanket, knife-over-roll, offset gravure, reverse roll, reverse-smoothing roll, rod and squeeze roll coating. Coat weights are variable and depend on the choice of facestock, the coating method and apparatus used, the desired drying time (both of the coating and ink to be imprinted thereon), and other factors known in the art. A label construction with a paper facestock can be prepared with an ink-receptive composition coat weight of, e.g., 10 to 20 g/m² (dry weight). In contrast, a plastic sheet protector may have a much lower coat weight, e.g., 7 to 10 g/m². Other applications may use substantially higher coat weights.

For label products, the composition can be applied using conventional techniques and processes, including coating “on-press” during the converting process (e.g., in concert with the processes of die-cutting, matrix stripping, etc.), coating “off-press” using a separate coater, and other application methods known in the art. After being coated or otherwise applied to a facestock or label stock, the composition is dried at room temperature or, more preferably, elevated temperature.

An ink-receptive construction according to the present invention is characterized by a substrate bearing one or more layers, including an outermost layer of a glossy topcoat comprising a composition as described above. Useful substrates include, without limitation, plastic film, especially transparent film, as well as paper, cardboard, corrugated board, metal film or foil, and other facestocks and label stocks traditionally used for ink printing application, particularly ink jet printing. Self-wound materials and other linerless materials are also suitable substrates. A nonlimiting example includes self-wound tapes.

Nonlimiting examples of plastic facestocks include polyester, polystyrene, polyvinyl chloride, nylon, and polyolefin (for example, polyethylene) films as well as polymer blends. The films may be cast, extruded, or coextruded. In some embodiments, film facestocks may be pre-treated with a primer or treated with a corona discharge to improve coating anchorage to the film.

Nonlimiting examples of paper facestocks include offset, bond, text, cover, index, lightweight printing paper, litho paper and sulfite paper.

Label stocks include, without limitation, a variety of printable label constructions or assemblies well known in the art, each typically comprising a label facestock (sheet or roll) having at least one inner and at least one outer surface, a pressure-sensitive adhesive (PSA) adhered to at least one inner surface of the label facestock, and a removable release liner protecting the PSA until use, the entire assembly forming a sandwich-like construction.

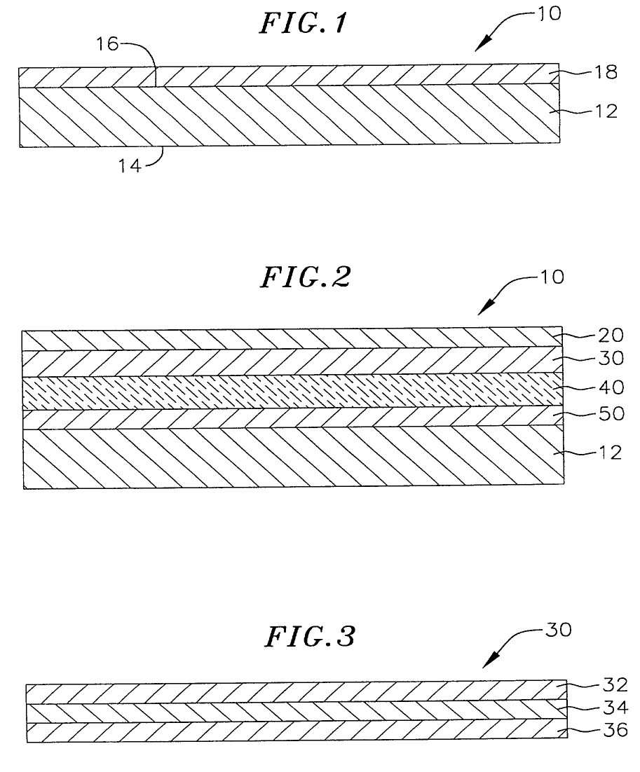

One embodiment of an ink-receptive construction according to the present invention is schematically illustrated in FIG. 1. The construction 10 has a facestock 12, having first (inner) and second (outer) surfaces 14 and 16, and a glossy topcoat 18 coated on the outer surface 16 of the facestock. One example of such an embodiment is an ink jet printing paper in which the facestock is a paper. Other examples sheet protectors and transparencies used with overhead projectors; in both cases the substrate is a transparent film material.

A more complex embodiment of an ink-receptive construction according to the present invention is schematically illustrated in FIG. 2. The construction 10 has a multilayer, sandwich-like structure in which several layers are coated on or laminated to a facestock 12, in the order shown. A glossy topcoat 20 comprising an ink-receptive composition as described herein is highly hydrophilic, preferably water swellable, but not water soluble. Aqueous inks can pass quickly through the topcoat but will not wash away or loose gloss when contacted with water or aqueous solutions. Preferably the topcoat layer is made as thin as possible.

An ink receiving and fixing layer 30 is comprised of a material capable of fixing the dyes in the ink, while allowing excess water to pass through the layer. For example, water soluble polymers containing one or more cationic functional groups, and/or other ingredients can be used as an ink-receiving and fixing layer. Where the multilayer construction is to be used with colored inks, it is preferred that layer 30 be substantially thick enough to accommodate all of the dies in the ink (e.g., cyan, magenta, yellow, and black) but not so thick that color is concentrated in a thin layer near the surface. Preferably, layer 30 is as clear as possible.

The water absorbent layer 40 is comprised of a highly porous material and can instantly absorb the water in an ink, without swelling. Non-limiting examples include microporous pigments and hollow microspheres. Preferably, the material has a high opacity and reflects light well. Non-limiting examples include collodial aluminum oxide, silica, zeolites, hollow microsphere polystrene, and hollow microsphere glass. Even water soluble materials can be used, as long as a crosslinker is included, so that upon crosslinking, layer 40 will not wash away. Alternatively, a water swellable, hydrophilic emulsion polymer can be used.

The water resistant layer 50 will stop water based inks from penetrating into the substrate 12, allowing paper substrates to be used. It also ensures that the quality of the ink image will not be affected by the structure of the base material (substrate) of the construction. Preferably, most of the ink in an imprinted image will reside in the topcoat layer to provide a high color density and sharp image.

The Substrate 12 can be any sheet material, including paper, plastic film, and the like, with flexible materials being preferred.

A multilayer construction as shown in FIG. 2 is designed to facilitate formation of a sharp, high color density image, with a glossy photograph-like appearance. Although not bound by theory, it is believed that an ink drop will quickly pass through the topcoat layer 20 into the ink receiving and fixing layer 30 where most of the dyes in the ink will be fixed by the active ingredients contained in the ink receiving and fixing layer. Excess water and remaining dyes are believed to go further into the structure and be absorbed by the water absorbent layer 40 and stopped by the water resistant layer 50.

It will be appreciated that the ink receiving and fixing layer 30 can itself have a multilayer structure. One embodiment of this concept is shown in FIG. 3. The ink receiving and fixing layer 30 has three layers 32, 34, and 36, each with different functions and materials. For example, layer 32 can fix yellow dyes, layer 34 can fix cyan dyes, and layer 36 can fix magenta dyes. Alternatively, the various layers making up ink receptive and fixing layer 30 configured such that one of the layers receives a basic dyes, another layer receives an acid dye, and still another layer receives a direct dye. Alternatively, the various layers 32, 34, 36, and additional layers (not shown) can be configured to preferentially receive the ink of a particular printer, for example Hewlett Packard, Canon, Epson, and other printers.

It will be appreciated that constructions as shown in any of FIGS. 1, 2, or 3 can be laminated to a pressure-sensitive adhesive (not shown), which, in turn, can be protected by a conventional release liner. The result is an adhesive label. In some embodiments, one or more die cuts can extend through all of the layers to, but not including, the release liner, allowing for the detachment of discrete labels. For example, a die-cut sheet of “clear ink jet labels” can be constructed with a plastic film facestock coated on one side with a pressure-sensitive adhesive (PSA) and on the other side with an ink-receptive topcoat. The PSA is protected by a release liner until the labels are to be applied to a surface. The facestock may be primed or corona discharge-modified to improve anchorage of the PSA and/or the topcoat. Such a sheet of labels can be fed through an ink jet printer, and individual inked labels can be removed from the release liner and applied to an envelope or other surface. Once applied, the labels are barely noticeable.

### EXAMPLES

The following are nonlimiting examples of amphoteric copolymers, ink-receptive compositions, and coated substrates prepared in accordance with the invention. The following abbreviations and product names are used in the tables:

| | |
|---|---|
| Monomers | |
| HEMA | Hydroxyethyl methacrylate |
| AA | Acrylic Acid |
| AMPS ® 2405 | Acrylamido-2-methylpropane sulfonic acid, |
| | sodium salt (50% aqueous solution), from |
| | Lubrizol Corp. |
| AgeflexFM1Q75MC | Dimethylaminoethylmethacrylate methyl chloride |
| | quaternary salt, from Ciba Specialty Chemicals |
| Polymers | |
| Airvol ® 540 | Polyvinyl alcohol (87-89% hydrolysis), from |
| | Air Products and Chemicals, Inc. |
| Klucel-L | Hydroxypropylcellulose (10% aqueous solution), |
| | from Hercules, Inc. |
| Gantrez ® A-425 | Copolymer of methyl vinyl ether and maleic |
| | acid mono-butyl ester (50% ethanol solution), |
| | from International Specialty Products |
| Polymer 1 | Amphoteric copolymer according to Example 1 |
| Polymer 2 | Amphoteric copolymer according to Example 2 |
| Pigments | |
| ST-PS-M | “Snowtex” colloidal silica (aqueous |
| | dispersion) , from Nissan Chemical Industries, |
| | Ltd. |
| MA-ST-UP | “Snowtex” colloidal silica (methanol |
| | dispersion), from Nissan Chemical Industries, |
| | Ltd. |
| Aluminasol #1 | Colloidal alumina hydrate (aqueous |
| | dispersion), from Nissan Chemical Industries, |
| | Ltd. |

Glycols and Surfactants

| | |
|---|---|
| Carbowax 4600 | Polyethylene glycol (M_{w} ≈ 4600),from Union |
| | Carbide |
| Tetronic ® 1102 | Block copolymer of ethylene oxide and |
| | propylene oxide, from BASF |
| Silwet 77 | Silicone surfactant, from CK Witco Corporation |
| Crosslinkers | |
| Sequarez 755 | Polyethoxylated dialdehyde, from GenCorp |
| Glyoxal | O═CHCH═O |
| Other | |
| DI H₂O | Deionized Water |

### Examples 1-3

### Amphoteric Copolymers

Using the monomers, initiators, and other components listed in Table 1, three amphoteric copolymers were prepared by free radical polymerization in water. In each case a reactor equipped with a thermometer, stirrer, and condenser was purged with nitrogen, charged with monomers and deionized water, and heated to 45° C. Under stirring, a reactor charge (RC) initiator was added in two steps: first (NH₄)₂S₂O₈ in water, then Na₂S₂O₅ in water. The reactor temperature rose to 60-65° C. in about 10 minutes, and was then kept at 65-70° C. for two hours, under nitrogen. A cook-off initiator was added to polymerize any residual monomers. The reactor was kept at 65-70° C. for one hour, and then allowed to cool. In Example 3, a base (sodium bicarbonate) was added after polymerization to raise the pH of the polymer solution.

TABLE 1
Amphoteric Coplymers: Examples 1-3

| | Example 1 | | | | Example 2 | | | | Example 3 | | | |
|---|---|---|---|---|---|---|---|---|---|---|---|---|
| Reactor Charge | | | | | | | | | | | | |
| -Monomer mix | mass | active | wt % | mol % | mass | active | wt. % | mol % | mass (g) | active (g) | wt. % | mol % |
| | (g) | (g) | | | (g) | (g) | | | | | | |
| -- HEMA | 0.0 | 0.0 | 0.0 | 0.0 | 20.0 | 20.0 | 10.0 | 15.7 | 20.0 | 20.0 | 10.0 | 16.3 |
| -- AA | 10.0 | 10.0 | 10.0 | 24.3 | 8.0 | 8.0 | 4.0 | 10.0 | 4.0 | 4.0 | 2.0 | 5.2 |
| -- AMPS 2405 (50%) | 40.0 | 20.0 | 20.0 | 16.9 | 40.0 | 20.0 | 10.0 | 8.7 | 32.0 | 16.0 | 8.0 | 7.2 |
| -- AgeflexFM1Q75MC | 93.3 | 70.0 | 70.0 | 58.8 | 202.7 | 152.0 | 76.0 | 65.6 | 213.3 | 160.0 | 80.0 | 71.4 |
| -- total monomers | 143.3 | 100 | 100% | 100% | 270.7 | 200 | 100% | 100% | 269.3 | 200 | 100% | 100% |
| —DI H₂O | 100 | | | | 260 | | | | 260 | | | |
| RC Initiator | | | | | | | | | | | | |
| —(NH₄)₂S₂O₈ | 0.050 | | 0.0002 | | 0.100 | | 0.05% | | 0.100 | | 0.05% | |
| —H₂O | 5.0 | | | | 10.0 | | | | 10.0 | | | |
| —Na₂S₂O₅ | 0.021 | | 0.0001 | | 0.042 | | | | 0.042 | | | |
| —H₂O | 5.0 | | | | 10.0 | | | | 10.0 | | | |
| Cook-off initiator | | | | | | | | | | | | |
| —(NH₄)₂S₂O₈ | 0.050 | | 0.0002 | | 0.100 | | 0.05% | | 0.100 | | 0.05% | |
| —H₂O | 5.0 | | | | 30.0 | | | | 50.0 | | | |
| —Na₂S₂O₅ | 0.021 | | 0.0001 | | 0.042 | | | | 0.042 | | | |
| —H₂O | 5.0 | | | | 30.0 | | | | 50.0 | | | |
| total reaction | 263.4 | | | | 610.9 | | | | 649.6 | | | |
| total solids | | | 38.0% | | | | 32.8% | | | | 30.8% | |
| Base Solution | None | | | | None | | | | | | | |
| H₂O | | | | | | | | | 100.0 | | | |
| NaHCO₃ | | | | | | | | | 4.20 | | | |
| Additional H₂O | | | | | | | | | 100.0 | | | |
| Final Volume | | | | | | | | | 849.6 | | | |
| Final Solids | | | | | | | | | 23.5% | | | |

### Examples 4-14

### Ink-Receptive Compositions

Using the components listed in Table 2, ink-receptive compositions were prepared by blending the components together, with stirring. Examples 4-6 are comparative examples, as they lack an amphoteric polymer and/or a polyalkylene glycol or silicone. In each of examples 7-14, the amphoteric polymer was added last, to avoid precipitation.

TABLE 2
Ink Receptive Compositions: Ex. 4-14

| | | | | |
|---|---|---|---|---|
| Component | amount (g) | active % | active (g) | weight % |

Ex. 4

| | | | | |
|---|---|---|---|---|
| - Airvol540 | 20 | 11.6% | 2.32 | 25.3% |
| - ST-PS-M | 32 | 21.0% | 6.72 | 73.4% |
| - Sequarez755 | 0.6 | 20.0% | 0.12 | 1.31% |
| Total | 52.60 | 17.4% | 9.16 | 100.0% |

Ex. 5

| | | | | |
|---|---|---|---|---|
| - Airvol540 | 20 | 11.6% | 2.32 | 23.7% |
| - Aluminasol#1 | 38 | 19.2% | 7.30 | 74.6% |
| - Silwet77 | 0.04 | 100.0% | 0.04 | 0.41% |
| - Sequarez755 | 0.6 | 20.0% | 0.12 | 1.23% |
| Total | 58.64 | 16.7% | 9.78 | 100.0% |

Ex. 6

| | | | | |
|---|---|---|---|---|
| - Gantrez A425 | 12 | 50.0% | 6.00 | 33.3% |
| - MA-ST-UP | 80 | 15.0% | 12.00 | 66.7% |
| Total | 92.00 | 19.6% | 18.00 | 100.0% |

Ex. 7

| | | | | |
|---|---|---|---|---|
| - Airvol540 | 25.9 | 11.6% | 3.00 | 30.0% |
| - Polymer 1 | 0.6 | 23.5% | 0.15 | 1.5% |
| - Aluminasol#1 | 34.9 | 19.2% | 6.70 | 67.0% |
| - Silwet77 | 0.050 | 100.0% | 0.05 | 0.50% |
| - Sequarez755 | 0.500 | 20.0% | 0.10 | 1.00% |
| Total | 61.95 | 16.1% | 10.00 | 100.0% |

Ex. 8

| | | | | |
|---|---|---|---|---|
| - Aluminasol#1 | 7.0 | 19.2% | 1.34 | 10.00% |
| - Airvol540 | 69.3 | 9.1% | 6.31 | 47.00% |
| - Carbowax460 | 0.83 | 40.0% | 0.33 | 2.50% |
| - Sequarez755 | 0.33 | 20.0% | 0.07 | 0.50% |
| - Polymer 1 | 22.8 | 23.5% | 5.36 | 40.00% |
| Total | 100.26 | 13.4% | 13.41 | 100.00% |

Ex. 9

| | | | | |
|---|---|---|---|---|
| - Aluminasol#1 | 7.0 | 19.2% | 1.34 | 10.10% |
| - Airvol540 | 83.6 | 9.1% | 7.61 | 57.00% |
| - Carbowax460 | 0.82 | 40.0% | 0.33 | 2.50% |
| - Sequarez755 | 0.33 | 20.0% | 0.07 | 0.50% |
| - Polymer 1 | 17.0 | 23.5% | 4.00 | 29.90% |
| Total | 108.75 | 12.3% | 13.34 | 100.00% |

Ex. 10

| | | | | |
|---|---|---|---|---|
| - Aluminasol#1 | 7.0 | 19.2% | 1.34 | 10.00% |
| - Airvol540 | 77.5 | 11.6% | 8.99 | 67.00% |
| - Carbowax460 | 0.83 | 40.0% | 0.33 | 2.50% |
| - Sequarez755 | 0.33 | 20.0% | 0.07 | 0.50% |
| - Polymer 1 | 11.4 | 23.5% | 2.68 | 10.00% |
| Total | 97.06 | 13.8% | 13.41 | 100.00% |

Ex. 11

| | | | | |
|---|---|---|---|---|
| - Aluminasol#1 | 7.0 | 19.2% | 1.34 | 10.00% |
| - Airvol540 | 87.5 | 11.8% | 10.33 | 77.00% |
| - Carbowax460 | 0.83 | 40.0% | 0.33 | 2.50% |
| - Sequarez755 | 0.33 | 20.0% | 0.07 | 0.50% |
| - Polymer 1 | 5.7 | 23.5% | 1.34 | 10.00% |
| Total | 101.36 | 13.2% | 13.41 | 100.00% |

Ex. 12

| | | | | |
|---|---|---|---|---|
| - Aluminasol#1 | 22.0 | 19.2% | 4.22 | 10.10% |
| - Airvol540 | 285.0 | 9.6% | 27.36 | 65.60% |
| - Carbowax460 | 2.49 | 40.0% | 1.00 | 2.40% |
| - Sequarez755 | 1.15 | 20.0% | 0.23 | 0.60% |
| - Polymer 1 | 37.8 | 23.5% | 8.88 | 21.30% |
| Total | 348.44 | 12.0% | 41.69 | 100.00% |

Ex. 13

| | | | | |
|---|---|---|---|---|
| - Airvol540 | 74.0 | 9.3% | 6.88 | 63.90% |
| - Klucel -L | 16.0 | 10.0% | 1.60 | 14.90% |
| - Polymer 2 | 7.6 | 28.0% | 2.13 | 19.80% |
| - Tetronic1102 | 0.11 | 100.0% | 0.11 | 1.00% |
| - H₂O | 0.0 | 0.0% | 0.00 | 0.00% |
| - Sequarez755 | 0.27 | 20.0% | 0.05 | 0.50% |
| Total | 97.98 | 11.0% | 10.77 | 100.10% |

Ex. 14

| | | | | |
|---|---|---|---|---|
| - Airvol540 | 124.0 | 9.0% | 11.41 | 65.20% |
| - Polymer 2 | 17.5 | 28.0% | 4.90 | 28.00% |
| - Tetronic1 102 | 0.51 | 100.0% | 0.51 | 2.90% |
| - Carbowax4600 | 0.49 | 100.0% | 0.49 | 2.80% |
| - H₂O | 5.0 | 0.0% | 0.00 | 0.00% |
| - Sequarez755 | 0.88 | 20.0% | 0.18 | 1.00% |
| Total | 148.38 | 11.8% | 17.49 | 99.90% |

### Ink-Receptive Compositions

Paper and film substrates can be coated with an ink-receptive composition (e.g., Examples 4-12) to prepare an ink-receptive construction. Polymer crosslinking is readily accomplished by drying the coated substrate for 5 minutes at 170 to 190° F. The crosslinked, topcoated construction can then be imaged in a printer (e.g., an ink jet printer) and evaluated for image quality, ink drying time, waterfastness, and other properties. Preliminary tests reveal that ink-receptive constructions prepared with Examples 7-12 are superior to Examples 4-6 in image quality and waterfastness.

A drawable and writable photo album, in which an outer surface of the photo album is coated with an ink-receptive composition according to the present invention, is described in detail in the U.S. patent application entitled “Drawable and Writable Photo Album,” to be filed concurrently herewith. The photo album is designed to permit a user to write text or draw pictures on the surface of the photo album with an ink pen, for example, a gel-based ink pen. A copy of the application is attached hereto as an Appendix, and its entire contents are made a part of this application.

In view of the preceding description, it will be apparent to persons skilled in the art that a number of modifications can be made without departing from the invention, the scope of which is limited only by the following claims. Throughout the text and the claims, use of the word “about” in relation to a range of number is intended to modify both the low and the high values stated.

What is claimed is:

1. A composition comprising: a mixture of a water soluble nonionic polymer; a water soluble amphoteric copolymer; and a polyalkylene glycol or silicone surfactant.

2. A composition as recited in claim 1, wherein the nonionic polymer is selected from the group consisting of polyvinyl alcohol, water soluble cellulose derivatives, gelatin, and chitosan.

3. A composition as recited in claim 1, wherein the nonionic polymer comprises a cellulose derivative selected from the group consisting of hydroxyethylcellulose, hydroxypropylcellulose, carboxymethylcellulose, methylhydroxycellulose, and methylhydroxypropyl cellulose.

4. A composition as recited claim 1, wherein the amphoteric copolymer is formed from a plurality of monomers comprising about 50 to 90% by weight cationic monomers, about 10 to 30% by weight anionic monomers, and 0 to about 30% by weight neutral monomers.

5. A composition as recited in claim 4, wherein the plurality of monomers comprises about 60 to 80% cationic monomers, about 10 to 20% anionic monomers, and about 10 to 20% neutral monomers.

6. A composition as recited in claim 4, wherein the cationic monomers are selected from the group consisting of trialkylammoniumalkyl (meth)acrylates, allylalkyl ammonium salts, and vinylbenzylammonium salts.

7. A composition as recited in claim 4, wherein the anionic monomers are selected from the group consisting of (meth)acrylic acid and acrylamido-2-methylpropane sulfonic acid.

8. A composition as recited in claim 4, wherein the neutral monomers are selected from the group consisting of acrylamide, dialkylaminoalkyl (meth)acrylates, hydroxyalkyl (meth)acrylates, and N-vinyloxazolidone.

9. A composition as recited in claim 1, wherein the amphoteric copolymer is formed from a plurality of monomers comprising about 60 to 80% dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.

10. A composition as recited in claim 1, wherein the nonionic polymer comprises a polyvinyl alcohol having a saponification level of about 85 to 95%.

11. A composition as recited in claim 1, wherein the polyalkylene glycol or silicone surfactant comprises a polyethylene glycol having a weight-average molecular weight of at least 600.

12. A composition as recited in claim 1, further comprising a crosslinker.

13. A composition as recited in claim 12, wherein the crosslinker is a dialdehyde.

14. A composition as recited in claim 13, wherein the crosslinker is glyoxal.

15. A composition as recited in claim 13, wherein the crosslinker is a polyethoxylated dialdehyde.

16. A composition as recited in claim 1, further comprising a pigment.

17. A composition as recited in claim 16, wherein the pigment comprises a colloidal silica.

18. A composition as recited in claim 16, wherein the pigment comprises a colloidal alumina hydrate.

19. A composition as recited in claim 1, wherein the nonionic copolymer comprises polyvinyl alcohol, the amphoteric copolymer comprises a copolymer of trialkylammonimumalkyl (meth)acrylate monomers, acrylic acid, acrylamido-2-methylpropane sulfonic acid, and hydroxyethyl methacrylate, and the polyalkylene glycol or silicone surfactant comprises polyethylene glycol.

20. A composition as recited in claim 1, wherein the mixture is crosslinked.

21. A composition as recited in claim 1, wherein the mixture comprises about 50 to 90% by weight nonionic polymer, about 10 to 50% amphoteric copolymer, and about 1 to 5% polyalkylene glycol or silicone surfactant.

22. A crosslinked mixture of components forming a topcoat for an ink-receptive medium, said mixture comprising, prior to crosslinking: a water soluble nonionic polymer; a water soluble amphoteric copolymer; and a polyalkylene glycol or silicone surfactant.

23. A crosslinked mixture as recited in claim 22, wherein the nonionic polymer is selected from the group consisting of polyvinyl alcohol, water soluble cellulose derivatives, gelatin, and chitosan.

24. A crosslinked mixture as recited in claim 22, wherein the amphoteric copolymer is formed from a plurality of monomers comprising about 50 to 90% by weight cationic monomers, about 10 to 30% by weight anionic monomers, and 0 to about 30% by weight neutral monomers.

25. A crosslinked mixture as recited in claim 22, wherein the plurality of monomers comprises about 60 to 80% cationic monomers, about 10 to 20% anionic monomers, and about 10 to 20% neutral monomers.

26. A crosslinked mixture as recited in claim 24, wherein the cationic monomers are selected from the group consisting of trialkylammoniumalkyl (meth)acrylates, allylalkyl ammonium salts, and vinylbenzylammonium salts.

27. A crosslinked mixture as recited in claim 24, wherein the anionic monomers are selected from the group consisting of (meth)acrylic acid and acrylamido-2-methylpropane sulfonic acid.

28. A crosslinked mixture as recited in claim 24, wherein the neutral monomers are selected from the group consisting of acrylamide, dialkylaminoalkyl (meth)acrylates, hydroxyalkyl (meth)acrylates, and N-vinyloxazolidone.

29. A crosslinked mixture as recited in claim 22, wherein the amphoteric copolymer is formed from a plurality of monomers comprising about 60 to 80% dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.

30. A crosslinked mixture as recited in claim 22, wherein the nonionic polymer comprises a polyvinyl alcohol having a saponification level of about 85 to 95% or higher.

31. A crosslinked mixture as recited in claim 22, wherein the polyalkylene glycol or silicone surfactant comprises a polyethylene glycol having a weight-average molecular weight of at least 600.

32. A crosslinked mixture as recited in claim 22, wherein the nonionic copolymer comprises polyvinyl alcohol, the amphoteric copolymer comprises a copolymer of trialkylammoniumalkyl (meth)acrylate, acrylic acid, acrylamido-2-methylpropane sulfonic acid, and hydroxyethyl methacrylate, and the polyalkylene glycol or silicone surfactant comprises polyethylene glycol.

33. A crosslinked mixture as recited in claim 22, wherein the mixture comprises about 50 to 90% by weight nonionic polymer, about 10 to 50% amphoteric copolymer, and about 1 to 5% polyalkylene glycol or silicone surfactant.

34. An ink-receptive construction, comprising: a paper or film substrate coated with one or more layers of material, including a crosslinked layer formed from a mixture of components comprising, prior to crosslinking, at least a water soluble nonionic polymer, a water soluble amphoteric copolymer, and a polyalkylene glycol or silicone surfactant.

35. An ink-receptive construction as recited in claim 34, wherein the nonionic polymer is selected from the group consisting of polyvinyl alcohol, water soluble cellulose derivatives, gelatin, and chitosan.

36. An ink-receptive construction as recited in claim 34, wherein the amphoteric copolymer is formed from a plurality of monomers comprising about 50 to 90% by weight cationic monomers, about 10 to 30% by weight anionic monomers, and 0 to about 30% by weight neutral monomers.

37. An ink-receptive construction as recited in claim 36, wherein the plurality of monomers comprises about 60 to 80% cationic monomers, about 10 to 20% anionic monomers, and about 10 to 20% neutral monomers.

38. An ink-receptive construction as recited in claim 36, wherein the cationic monomers are selected from the group consisting of trialkylammoniumalkyl (meth)acrylates, allylalkyl ammonium salts, and vinylbenzylammonium salts.

39. An ink-receptive construction as recited in claim 36, wherein the anionic monomers are selected from the group consisting of (meth)acrylic acid and acrylamido-2-methylpropane sulfonic acid.

40. An ink-receptive construction as recited in claim 36, wherein the neutral monomers are selected from the group consisting of acrylamide, dialkylaminoalkyl (meth)acrylates, hydroxyalkyl (meth)acrylates, and N-vinyloxazolidone.

41. An ink-receptive construction as recited in claim 34, wherein the amphoteric copolymer is formed from a plurality of monomers comprising about 60 to 80% dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.

42. An ink-receptive construction as recited in claim 34, wherein the nonionic polymer comprises a polyvinyl alcohol having a saponification level of about 85 to 95%.

43. An ink-receptive construction as recited in claim 34, wherein the polyalkylene glycol or silicone surfactant comprises a polyethylene glycol having a weight-average molecular weight of at least 600.

44. An ink-receptive construction as recited in claim 34, wherein the nonionic copolymer comprises polyvinyl alcohol, the amphoteric copolymer comprises a copolymer of trialkylammoniumalkyl (meth)acrylate, acrylic acid, acrylamido-2-methylpropane sulfonic acid, and hydroxyethyl methacrylate, and the polyalkylene glycol or silicone surfactant comprises polyethylene glycol.

45. An ink-receptive construction as recited in claim 34, wherein the outermost layer further comprises a pigment.

46. An ink-receptive construction as recited in claim 45, wherein the pigment comprises a colloidal silica.

47. An ink-receptive construction as recited in claim 45, wherein the pigment comprises a colloidal alumina hydrate.

48. A composition comprising: a mixture of about 50 to 90% by weight of a water soluble, nonionic polymer, about 10 to 50% of an amphoteric copolymer, and about 1 to 5% of a polyalkylene glycol or silicone surfactant.

49. A composition comprising: a mixture of about 50 to 90% by weight of a water soluble, nonionic polymer; about 10 to 50% of an amphoteric copolymer formed of a plurality of monomers comprising about 60 to 80% by weight cationic monomers, about 10 to 20% anionic monomers, and about 10 to 20% neutral monomers; and about 1 to 5% of a polyalkylene glycol or silicone surfactant.

50. A composition as recited in claim 49, wherein the amphoteric copolymer is formed from a plurality of monomers comprising about 60 to 80% by weight dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.

51. A crosslinked mixture of components forming a topcoat for an ink-receptive medium, said mixture comprising, prior to crosslinking: about 50 to 90% by weight of a water soluble, nonionic polymer, about 10 to 50% of an amphoteric copolymer, and about 1 to 5% of a polyalkylene glycol or silicone surfactant.

52. A crosslinked mixture of components forming a topcoat for an ink-receptive medium, said mixture comprising, prior to crosslinking: about 50 to 90% by weight of a water soluble, nonionic polymer; about 10 to 50% of an amphoteric copolymer formed of a plurality of monomers comprising about 60 to 80% by weight cationic monomers, about 10 to 20% anionic monomers, and about 10 to 20% neutral monomers; and about 1 to 5% of a polyalkylene glycol or silicone surfactant.

53. A crosslinked mixture as recited in claim 52, wherein the amphoteric copolymer is formed from a plurality of monomers comprising about 60 to 80% by weight dimethylaminoethyl methacrylate methyl chloride quaternary salt; acrylic acid and acrylamido-2-mthylpropane sulfonic acid in a combined amount of about 10 to 20%; and about 10 to 20% hydroxyethylmethacrylate.

54. An ink-receptive construction, comprising: a paper or film substrate coated with one or more layers of material, including a crosslinked layer formed from a mixture of components comprising, prior to crosslinking, about 50 to 90% by weight of a water soluble, nonionic polymer, about 10 to 50% of an amphoteric copolymer, and about 1 to 5% of a polyalkylene glycol or silicone surfactant.

55. An ink-receptive construction, comprising: a paper or film substrate coated with one or more layers of material, including a crosslinked layer formed from a mixture of components comprising, prior to crosslinking, about 50 to 90% by weight of a water soluble, nonionic polymer; about 10 to 50% of an amphoteric copolymer formed of a plurality of monomers comprising about 60 to 80% by weight cationic monomers, about 10 to 20% anionic monomers, and about 10 to 20% neutral monomers; and about 1 to 5% of a polyalkylene glycol or silicone surfactant.

56. An ink-receptive construction as recited in claim 55, wherein the amphoteric copolymer is formed from a plurality of monomers comprising about 60 to 80% by weight dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.

57. An amphoteric copolymer formed from a plurality of monomers comprising about 60 to 80% by weight dimethylaminoethyl methacrylate methyl chloride quaternary salt; acrylic acid and acrylamido-2-methylpropane sulfonic acid in a combined amount of about 10 to 20%; and about 10 to 20% hydroxyethylmethacrylate.
